(19) United States
(12) Patent Application Publication
(10) Pub. No.: US 2014/0331464 A1
(43) Pub. Date: Nov. 13, 2014

(54) COUPLING HOUSING CONNECTOR PULL TAB

(71) Applicant: Amphenol Fiber Optics Technology (Shenzhen), Shenzhen City (CN)

(72) Inventors: Bolin JIANG, Shenzhen City (CN); Songsheng LI, Shenzhen City (CN); Min CHEN, Shenzhen City (CN); Linghua ZHU, Shenzhen City (CN)

(73) Assignee: Amphenol Fiber Optics Technology (Shenzhen), Shenzhen City (CN)

(21) Appl. No.: 14/020,158

(22) Filed: Sep. 6, 2013

(30) Foreign Application Priority Data
May 7, 2013 (TW) 102208427

(51) Int. Cl. G02B 6/38

(52) U.S. Cl. CPC G02B 6/3807
USPC 29/283

(57) ABSTRACT

An apparatus is for disconnecting an optical fiber connector assembly from an adaptor. The optical fiber connector assembly includes an optical fiber wire set. The apparatus includes an engaging unit and a gripping bar. The engaging unit is configured to detachably engage a connector body of the optical fiber connector assembly, and defines a containing space so as to contain the connector body therein. The gripping bar extends from the engaging unit. The engaging unit includes a base that is configured to abut against a top or bottom surface of the connector body, and a pair of jaws each formed on a respective one of a pair of opposite lateral sides of the base. The containing space is defined cooperatively by the base and the jaws.

### CROSS-REFERENCE TO RELATED APPLICATION

This application claims priority of Taiwanese Application No. 102208427, filed on May 7, 2013.

### BACKGROUND OF THE INVENTION

1. Field of the Invention

The invention relates to an apparatus used for disconnecting an optical fiber connector assembly from an adaptor, more particularly to an apparatus that has a relatively simple structure and that enables easy operation to disconnect the optical fiber connector assembly from the adaptor.

2. Description of the Related Art

Fiber-optic communication adopts optical fibers for transmitting data, such as telephone signals, television signals, and Internet signals. Due to a number of advantages such as a larger transmitting rate, a smaller size, and a significantly lower interference, the fiber-optic communication has gradually replaced the conventional copper-wire communication as a primary means for information transmission.

The optical fiber wire transmits signals in the form of light, which propagates within the optical fiber wire through total internal reflection. As a result, in order to not compromise the data transmission, it is strongly desired that the optical fiber wire be kept from being bent or ruptured when removing the optical fiber wire.

FIG. 1 illustrates an optical fiber connector assembly 1 that includes an optical fiber wire set 11 and a connector body 12 that is capable of removably interconnecting one end of the optical fiber wire set 11 to a port of an adaptor. The connector body 12 may be coupling housing connector, such as a multi-fiber push on (MPO) connector.

Using the optical fiber connector assembly 1 shown in FIG. 1, a user is able to reconfigure a communication network with a large number of optical fiber wire sets 11 by manually holding the connector bodies 12 and connecting/disconnecting the same to/from the respective ports. Such configuration effectively reduces the risk of damaging the optical fiber wires.

However, since communication networks nowadays generally consist of a large number of optical fiber wire sets 11 and ports, reconfiguring the communication network, which usually involves frequent switching of connections of various optical fiber wire sets 11 among respective ports of the adaptor, may become difficult and time-consuming. Additionally, it is common to scale down the optical fiber wire set 11 and the connector body 12 in order to make it possible to arrange more optical fiber connector assemblies 1 in a given space (e.g., a machine room). Subsequently, while a higher density is achieved, less space is left between adjacent optical fiber wire sets 11, making the manual reconfiguration even more inconvenient.

### SUMMARY OF THE INVENTION

Therefore, the object of the present invention is to provide an apparatus that makes it easy to disconnect an optical fiber connector assembly from an adaptor, and that reduces the risk of damaging optical fiber wires during reconfiguration.

Accordingly, an apparatus of the present invention is for disconnecting an optical fiber connector assembly from an adaptor. The optical fiber connector assembly includes an optical fiber wire set extending along a first direction, and a connector body removably interconnecting one end of the optical fiber wire set to the adaptor. The apparatus comprises an engaging unit and a gripping bar.

The engaging unit is configured to detachably engage the connector body of the optical fiber connector assembly. The engaging unit defines a containing space so as to contain the connector body therein, thereby inhibiting movement of the connector body with respect to the engaging unit.

The gripping bar extends from the engaging unit along the first direction.

The engaging unit includes a base and a pair of jaws. The base is configured to abut against a top or bottom surface of the connector body. Each of the pair of jaws is formed on a respective one of a pair of opposite lateral sides of the base. The containing space is defined cooperatively by the base and the jaws.

### BRIEF DESCRIPTION OF THE DRAWINGS

Other features and advantages of the present invention will become apparent in the following detailed description of the preferred embodiment with reference to the accompanying drawings, of which:

FIG. 1 illustrates an optical fiber connector assembly having a multi-fiber push on (MPO) connector body;

FIG. 2 is a perspective view of a preferred embodiment of an apparatus according to the invention;

FIG. 3 is a front view of the apparatus of FIG. 2; FIG. 4 is a sectional view of the apparatus of FIG. 2;

FIG. 5 is a sectional view illustrating the apparatus being used to engage the connector body; and

FIG. 6 is a bottom view of FIG. 5.

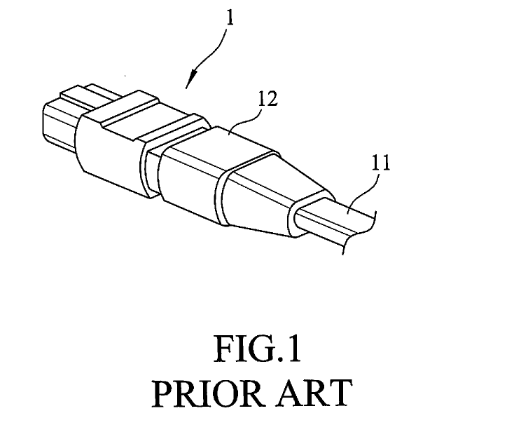

### DETAILED DESCRIPTION OF THE PREFERRED EMBODIMENT

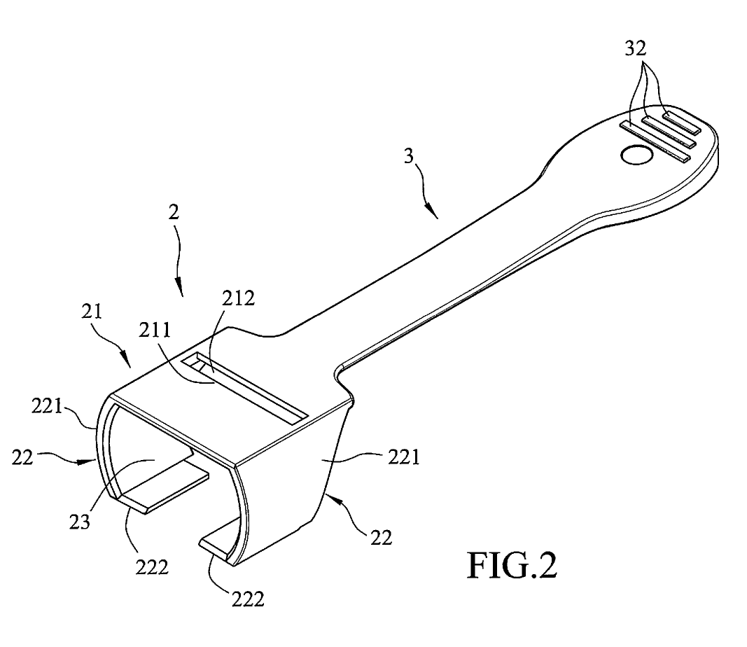

As shown in FIG. 2, the preferred embodiment of an apparatus according to the present invention comprises an engaging unit 2 and a gripping bar 3.

The engaging unit 2 includes a base 21 and a pair of jaws 22. The base 21 and the jaws 22 cooperatively define a containing space 23.

Each of the jaws 22 is formed on a respective one of a pair of opposite lateral sides of the base 21. Specifically, each of the jaws 22 has an extending part 221 that extends integrally from the base 21, and an angled tip 222 that extends integrally from an end of the extending part 221 distal from the base 21.

The gripping bar 3 extends integrally from the base 21, and allows gripping by a user thereof. Furthermore, the gripping bar 3 includes an anti-slip pattern 32 disposed on an end of the gripping bar 3 that is distal from the base 21. The anti-slip pattern 32 enhances traction at the surface of the gripping bar 3. In this embodiment, the anti-slip pattern 32 is in the form of a plurality of ridges, but other forms, such as grooves, may be employed in order to achieve the same anti-slip effect.

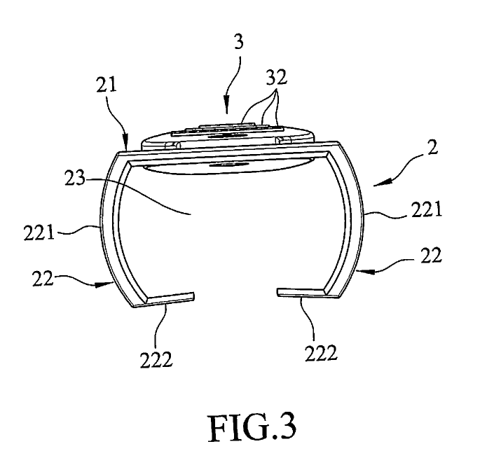

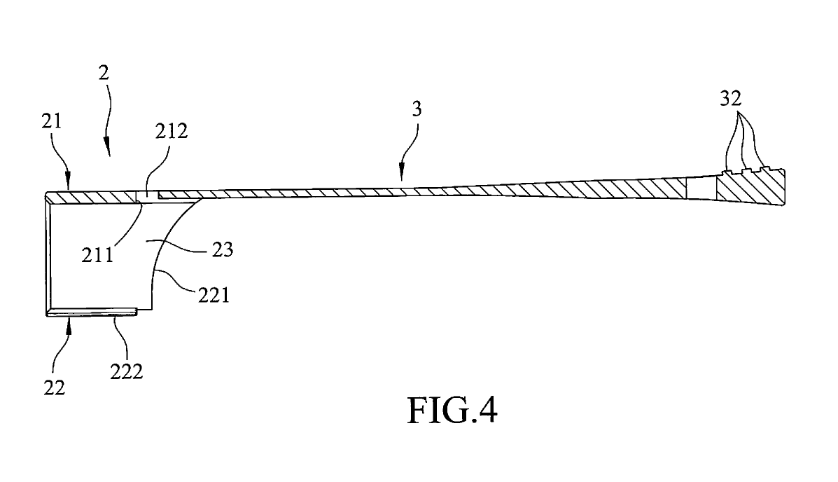

With reference to FIGS. 3 and 4, the base 21 is formed with an abutting portion 211 that is disposed to face the gripping bar 3, and that has a thickness that is larger than that of the gripping bar 3. The base 21 is further formed with an engaging groove 212 between the abutting portion 211 of the base 21 and the gripping bar 3.

The apparatus is intended to have an effect similar to that of a “pull tab”. That is, when it is desired to disconnect a housing of a connector from an adaptor, a user may simply attach the apparatus to the housing and apply a backward force to “pull” the apparatus back, which in turn disconnects the housing.

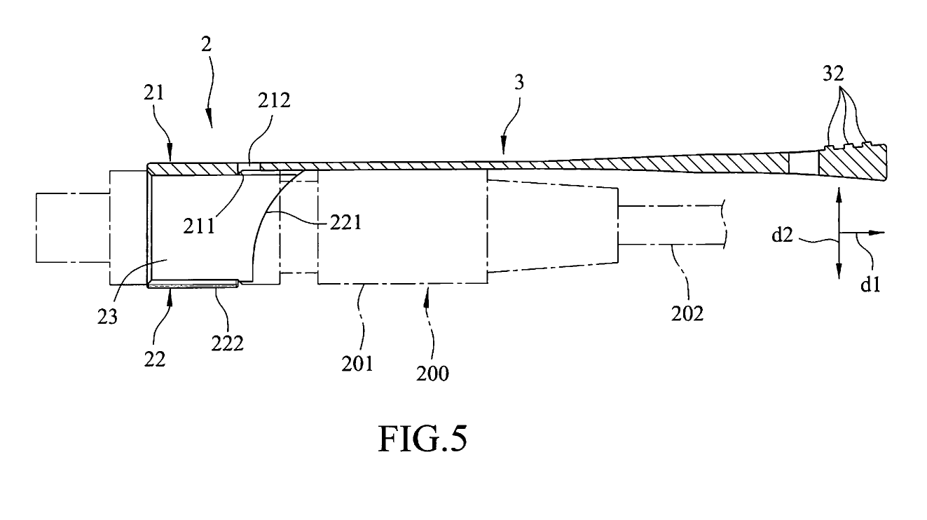

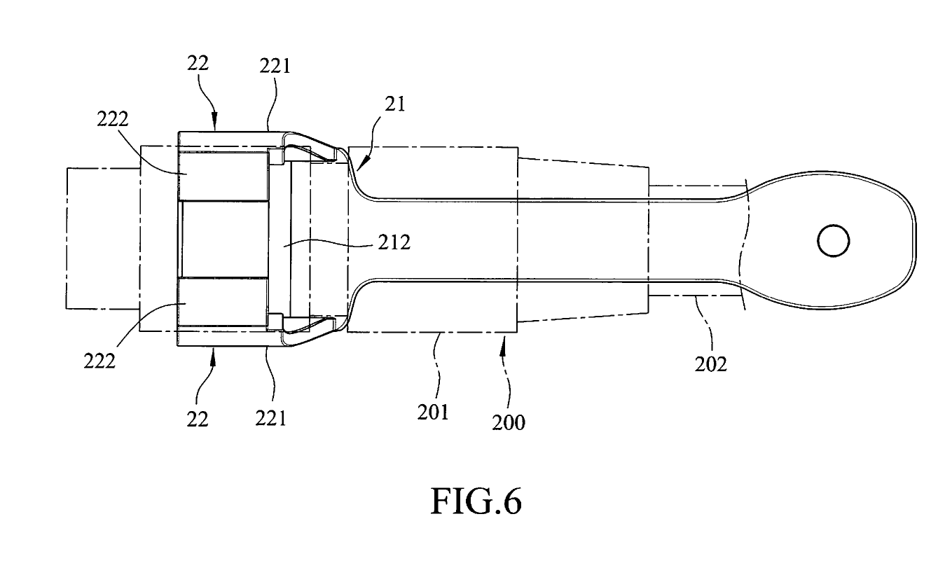

Referring to FIGS. 5 and 6, when in use, the engaging unit 2 is sleeved on a connector body 201 of an optical fiber connector assembly 200. The optical fiber connector assembly 200 includes an optical fiber wire set 202, and the connector body 201 is configured to removably interconnect one end of the optical fiber wire set 202 to a port of an adaptor (not shown in the drawings). In this embodiment, the connector body 201 is a multi-fiber push on (MPO) connector, but may be other types of coupling housing connectors, such as a subscriber connector or a standard connector (SC).

When the engaging unit 2 is sleeved on the connector body 201, the gripping bar 3 extends along a first direction parallel to the direction in which the optical fiber wire set 202 extends (indicated by the arrow (d₁) in FIG. 5, and facing away from the adaptor). The base 21 is configured to abut against one of a top surface and a bottom surface of the connector body 201, and the extending part 221 of each of the jaws 22 extends along a second direction that is perpendicular to the first direction (indicated by the arrow (d₂) in FIG. 5), and is configured to abut against a lateral side of the connector body 201. The angled tips 222 of the laws 22 are configured to abut against the other one of the top surface and the bottom surface of the connector body 201.

The abutting portion 211 and the engaging groove 212 are disposed to secure the connector body 201 within the containing space 23, such that movement of the connector body 201 with respect to the engaging unit 2 is inhibited. In other embodiments, the abutting portion 211 and the engaging groove 212 may be dimensioned in order to accommodate a different size or a different type of the connector body 201.

When it is desired to disconnect the optical fiber connector assembly 200 from the port of the adaptor, the user gripping on the gripping bar 3 may pull the apparatus along the first direction d₁. This applies a force on the engaging unit 2, which in turn passes the force to the connector body 201 secured in the containing space 23 by the abutting portion 211 and the angled tips 222. The resulting reaction is a movement of the connector body 201 in the first direction, and subsequent disconnection from the adaptor.

To sum up, the apparatus of the present invention allows the user to easily apply a force onto the connector body 201 along the first direction without having to grab the connector body 201 with his/her hand and pulling the connector body 201 out from the adaptor. The apparatus of the present invention further eliminates contact with the optical fiber wire set 202, thereby preventing possible damage when pulling. The apparatus of the present invention may be particularly useful when the optical fiber connector assembly 200 is in a dense communication network, where the connector body 201 is scaled down and the space between adjacent optical fiber connector assemblies 200 is narrow. Additionally, the apparatus of the present invention has a relatively simple structure, and can be easily dimensioned to accommodate a variety of connectors.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An apparatus for disconnecting an optical fiber connector assembly from an adaptor, the optical fiber connector assembly including an optical fiber wire set extending along a first direction, and a connector body removably interconnecting one end of the optical fiber wire set to the adaptor, said apparatus comprising:
an engaging unit configured to detachably engage the connector body of the optical fiber connector assembly, wherein said engaging unit defines a containing space so as to contain the connector body therein, thereby inhibiting movement of the connector body with respect to said engaging unit; and
a gripping bar extending from said engaging unit along the first direction;
wherein said engaging unit includes a base that is configured to abut against a top or bottom surface of the connector body, and a pair of jaws each formed on a respective one of a pair of opposite lateral sides of said base, and said containing space is defined cooperatively by said base and said jaws.

2. The apparatus of claim 1, further comprising an anti-slip pattern disposed on said gripping bar.

3. The apparatus of claim 1, wherein each of said jaws has an extending part that extends from said base along a second direction perpendicular to the first direction, and an angled tip that extends from an end of said extending part distal from said base.

4. The apparatus of claim 1, wherein said base is formed with an abutting portion that is disposed to face said gripping bar, and that has a thickness that is larger than that of said gripping bar.

5. The apparatus of claim 4, wherein said base is formed with an engaging groove between said abutting portion of said base and said gripping bar for engaging the connector body.
